(19) United States
(12) Patent Application Publication
(10) Pub. No.: US 2005/0184148 A1
(43) Pub. Date: Aug. 25, 2005

(54) Scale having nutritional information readouts

(76) Inventor: Jack Perlman, Vernon Hills, IL (US)

Correspondence Address: WELSH & KATZ, LTD, 120 S RIVERSIDE PLAZA, 22ND FLOOR, CHICAGO, IL, 60606, US

(21) Appl. No.: 10/809,574

(22) Filed: Mar. 25, 2004

Related U.S. Application Data
(60) Provisional application No. 60/547,247, filed on Feb. 24, 2004.

(51) Int. Cl. G06K 15/00

(52) U.S. Cl. 235/383

(57) ABSTRACT

A nutritional information scale having memory means to hold the nutritional data of various foods as well as a computer and input means to enter the type of food and determine nutritional values of the food based on the data stored and the weight of the portion provided. The device permits the use of the user's food containers and/or plate as the weight of the plate can be removed from the weight value, by virtue of a tare calculation. The memory of the device permits the user to store food values of various portions of foods and/or entire meals, and then display either the individual portion values or the values for an entire meal or series of meals. Further, values for more than one user can be provided and displayed.

### FIELD OF THE INVENTION

The present invention concerns a nutritional information scale. More particularly the present invention concerns a novel scale having means, including computer means, to provide a user with information concerning the nutritional value of foods weighed thereon as well as information for one or more meals, one or more users and/or one or more portions.

### BACKGROUND OF THE INVENTION

Scales of all types have been available for centuries, including scales used to weigh individual meal portions. Further, calculating devices and charts having information on general nutritional values of meals, such that a user can determine various nutritional values for different types of foods and, by independent computations, determine a general value for various nutritional components of meals have also been available.

Typically scales and calculators have been combined so that a user can weigh a portion of food and then, using general information about types of foods, calculate the number of calories that a particular portion of food contains. While this has been helpful in the calculation of recommended daily allowances of some foods, it generally does not provide information on other aspects of the foods, such as fat, sodium and carbohydrate levels.

While some dieting and other devices have provided users with more general nutritional values of a portion of food, it has typically not been possible to provide the information for an entire meal, information with respect to the nutritional value of a number of meals for a single person or for a number of persons in one or more days. As a result, nutritional information for an entire meal, or a number of meals has had to be calculated based on one portion at a time and the maintenance of a hand made, or similar, chart. Typically, users tire of keeping track of these values over a short period of time and the calculations are not made. As such, scales of the prior art have typically had a minimal use and then are relegated to the pile of unused products.

Further, it has been found that to be most effective, “diets” should be viewed not as a temporary change in eating habits—but a permanent change in life-style. To make such a change, the “dieter” needs to be conscious of what they are taking into their body, and the implications for their health and sense of well-being. While it has been found that the weight or amount of a food consumed is an important determination it is only one means to establish the key nutritional values it contains.

While determination of the weight of a portion of food and its nutritional content provides a convenient way to “stay on a diet”, it has been found that it is more important to gradually educate the “dieter” as to the nutrient content of a broad range of foods. When this is done, the “dieter” can then select foods and portions to truly effect the new and healthier life style sought. When this is done as a learning process, decisions will be made with confidence at the grocery store, in restaurants and other places where nutritional values in the form of actual numerical data isn't available. It is believed that eventually those taught such information and the means to obtain this information will become familiar with the nutritional content of many common foods, and will incorporate this knowledge into a healthier life style.

There has arisen a need for a device that can provide a user comprehensive information with respect to a meal regimen while educating the user with respect to the nutritional values of foods. Such a device can help a user to become educated in meal selection, including the selections of foods and the appropriate quantities so that appropriate choices for a healthy lifestyle are learned.

### SUMMARY OF THE INVENTION

In accordance with the present invention, a nutritional value determination, display and storage device is provided. The device comprises a scale for weighing foods and a computer having a microprocessor, one or more memory means and input means. In the device data, such as nutritional values of a large number of foods and beverages is stored in at least one of the one or more memory means. Further, a screen for viewing nutritional values of foods is provided such that when a portion of food is placed on the scale and the type of food is entered into the device by the input means, nutritional values can be determined by the microprocessor and displayed on the screen.

In one preferred embodiment of the scale device, once the nutritional values are determined, the values can be stored in one or more of the one or more memory means, so that the values can be reviewed at a later date and added to values determined for other portions of foods in the same meal or in a number of meals over a period of time.

In a preferred embodiment, the input means is a keyboard, either of a mechanical type or a screen generated touch pad, of types well known in the art, and the user enters data to aid in the calculation of nutritional values using the keyboard. In a preferred embodiment different functions of the device can be selected using the keyboard. For example, a user ID number can be entered such that data is stored for a particular user, and other users can store data as well. Further, the user can enter a specific code, identified with a particular food, so that stored data with respect to the nutritional values of the food can be recalled and used for calculations.

In the use of the device, when an item is placed on the scale, its weight is automatically displayed in a display window of the device. The user can then enter a food code, from a provided list, using the data entry means of the device, so that the nutritional values of the food being weighed can be determined. A microprocessor means reads the code and finds the appropriate nutritional values stored in a memory within the device. The values found in memory are used to determine the various nutritional values for the quantity of food determined by the scale. The values for the particular portion are then displayed on the screen and can be stored in memory for further uses.

In a preferred embodiment the scale can keep track of nutrition totals for up to four different users. In one embodiment, if food to be weighed is to be consumed by several persons, the scale can automatically divide the total weight by the number of portions to be made of the weighed food. In another embodiment the user can compute daily totals of portions entered.

In one preferred embodiment the device is a kitchen scale with nutritional content calculation capability. It can automatically calculate and show ten key nutritional contents (calories, calories from fat, carbohydrate, protein, fat, saturated fat, fiber, sugars, cholesterol and sodium) as well as equivalent value of bread of weighed food item.

In order to accurately measure the portion placed on the scale, in one embodiment the user may press a “TARE” key to set current weight as the tare weight. In this manner the user can use the container of his choice and determine accurate results with respect to the portion of food as the weight of the container is not factored into the calculations.

In one embodiment the scale allows user to enter nutrient values directly so that the user can determine the values associated with a potential meal and make a determination as to whether to prepare such a meal. In this embodiment, the user can add and subtract items from stored data to assist in meal planning and preparation.

A more detailed explanation of the invention is provided in the following description and claims and is illustrated in the accompanying drawings.

### BRIEF DESCRIPTION OF THE DRAWINGS

FIG. 1 is top planar view of a scale of the present invention.

FIG. 2 is a front elevational view of the scale of FIG. 1.

FIG. 3 is a side elevational view of the scale of FIG. 1.

FIG. 4 is a schematic view of an informational screen and input means of the device of the present invention.

FIG. 5 is a schematic representation of one embodiment of the device of the present invention.

FIG. 6 is a rear elevational view of another embodiment of the scale of the present invention.

### DETAILED DESCRIPTION OF AN ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

Referring to the figures, a scale 10 having a nutritional information readout screen 12 is shown. The scale 10 comprises a weighing platform 14 a main body 16 and keyboard 18. It will be understood, by persons having ordinary skill in the art, that screen 12 and keyboard 18 can be manufactured alternatively as a single unit or as separate input and readout devices. As a single unit, the screen/keyboard can be a single CRT type screen in which the keyboard is a touch screen type device that is created by software. In other embodiments, the keyboard and screen can be separate devices having traditional configurations. It will be understood that combinations of such elements can be used without departing from the novel scope of the present invention. Scale 10 further comprises memory locations 20, a microprocessor 22 and various input/output devices 24, which will be described in greater detail below.

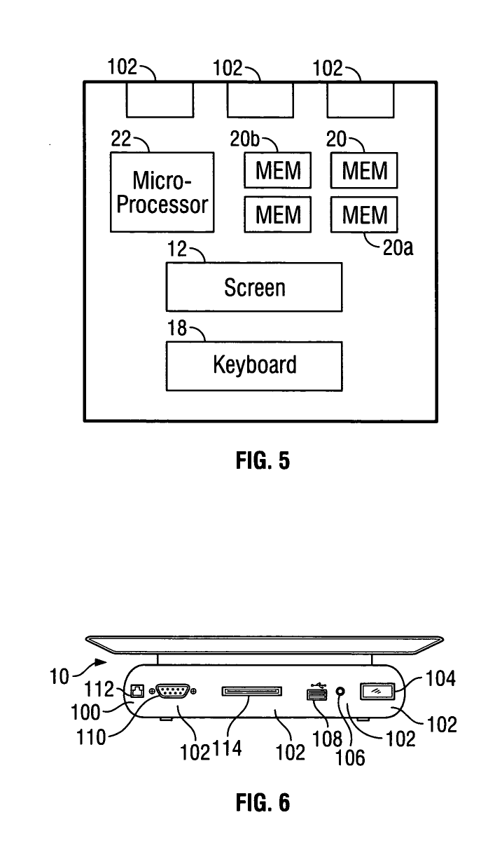

In the use of scale 10, a portion of food can be placed on weighing platform 14 to determine the weight of the food. A code can then be entered into the scale 10 via keyboard 18 to cause the microprocessor 22 to search a first memory 20a (FIG. 5) for nutritional values for the specific food placed on weighing means 14. The code data would include nutritional values for a specific unit of the food identified with the code. For example, if the food is boneless breast of chicken, the identified code data would include the nutritional values for one unit of boneless breast of chicken, perhaps one ounce. It will be understood by persons having skill in the art that one embodiment of the present invention can include input means such that the name of the food, or a category of food, can be simply entered, such as by using a keyboard, voice commands, or the like, into the scale, resulting in the microprocessor and memory means calling up the nutritional values for a unit of the input foods, without departing from the novel scope of the present invention. In a preferred embodiment, a booklet of codes is provided to the user and the type of food is entered into the scale using a three-digit code entered by using the numerical areas of keyboard 18. It will be understood by persons having ordinary skill in the art that any desirable number of digits to identify foods and food groups can be used with out departing from the novel scope of the present invention. The use of a three-digit code provides one thousand combinations of foods and food types.

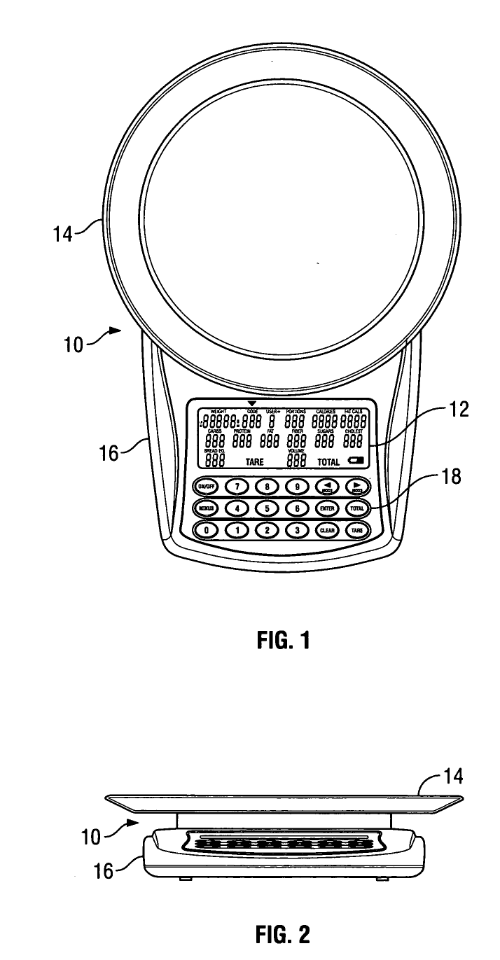

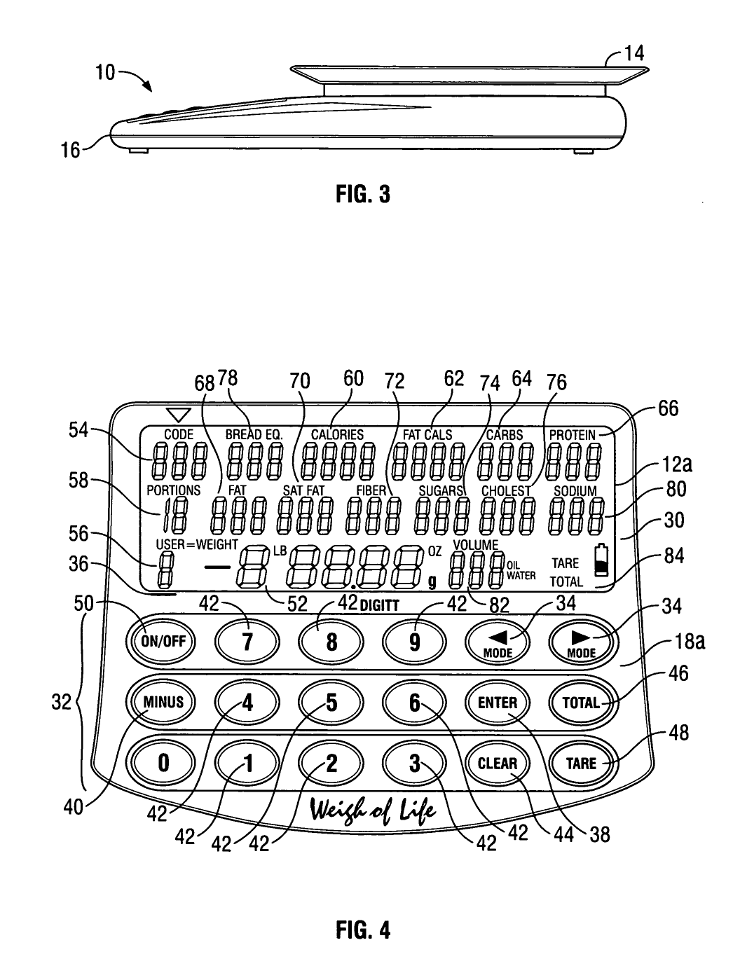

Referring to FIGS. 1 and 4 it will be seen that combination screen 12 and keyboard 18 (FIG. 1) and 12a and 18a (FIG. 4), respectively, can have different configurations based on the needs of the user and the capabilities of the particular device. For ease of viewing reference will be made to FIG. 4, the elements of screen 12a and Keyboard 18a can include all of the following, or any of the following in any desired combination, as desired. Screen 12a comprises a main viewing area 30 and keyboard 18a comprises a main input area 32. Viewing area 30 can be comprised of a thin LED screen, or any type of screen material known to persons having ordinary skill in the art, in one embodiment viewing area 30 can be created by dividing a flat surface into a specified number of areas, each area being represented by individual read out areas comprised of digital or numerical display means. Such means as those used in LED calculators, LCD calculators, lap top computer screens, plasma screen devices, projection devices and others can all be interchanged without departing from the novel scope of the present invention. Input area 32 can be comprised of materials similar to viewing area 30 along with touch screen technologies, or can be actual push buttons or pads as in standard key board entry devices.

Viewing area 30, as shown in FIG. 4, can be divided into 18 individual reading zones as described herein. Persons having skill in the art will understand that viewing area 30 can be configured in any way known in the art to provide the desired information and that the screen can be made such that more or less information can be displayed as required or desired by the users thereof The division of the screen into 18 individual areas is not meant as a limitation but only as a necessary instrument for the explanation of the various features of the present invention. It will be understood that keyboard 18, which can be configured as necessary and as described below to input information for viewing on screen 12a and for memory storage and computer usage, will be instrumental in the discussion of screen 12a and viewing area 30, and will be described in greater detail below. Referring again to FIG. 4, and specifically to the top left hand corner of viewing area 30, code display 32 is shown having a three-digit read out. The user of the device of the present invention will enter a code for the particular food type being weighed. For example, if a person places a portion of boneless chicken breast on the scale he would then enter the code for boneless chicken breast into the scale using the numerical key pad 18a. The microprocessor 22 would then search memory means 20a for the nutritional values for the food identified with the particular code entered, determine the weight of the portion being weighed and then calculate the values for the particular weight of the portion of the food being weighed, and cause those values to be displayed on the screen.

In a preferred embodiment of the present invention, a tare measurement can first be made to eliminate the weight of a container or plate, used to hold the portion of food, so that its weight is not considered in the determination of the nutritional values of the food. The tare measurement and readout will be described in greater detail below.

Referring again to FIG. 4, viewing area 30 and keyboard area 32 include the following elements “Mode” keys (symbolized generally as “>” and “<”) 34 are used to move a cursor 36, shown as an underlined segment, to the appropriate function for data entry. The use of the mode keys 34 will tend to place the device into one of several modes necessary to the use of the calculating features of the present invention. It will be understood that any kind of indications, an arrow, framing of a function or underlining can be used as a cursor indication without departing from the novel scope of the present invention. When framed or underlined, that mode becomes active, and keypad entries appear in that mode/function. It will also be understood that in the use of different types of screens and input devices the manner and mode of determining different functions can be changed. In one embodiment a screen of the type used in a personal or laptop computer may be used and the mode keys can be replaced by a mouse system using a menu features on a screen.

Other keys and data entry displays are generally intuitive in nature, however, for completeness, the following is a meant as a quick, but not exhaustive, explanation of the display or function. The “Enter” key 38, including in one example an enter key having a “+” function, adds selected numeric values to a total, or enters the selected number into applicable mode (e.g., number of portions). Also enter key 38 selects sub-modes (e.g., to display totalized or current values). The “Minus” key 40 permits the subtraction of selected numeric values from any total selected or derived. “Numeric” keys 42 permit the selection of numeric values (0 through 9) to be entered, relative to the selected mode. For example, when the “code mode” is selected the user would then enter a three-digit code, or other code, associated or assigned to the food or product to be weighed, using the numeric keys 42 to select the appropriate elements of the three digit code.

The “Clear” Key 44 deletes most recent numeric entry when the device is in the “active mode” when the key is pressed once. When the clear key 44 is pressed a second time, in one embodiment, the device will ask for confirmation of the user's intent to delete a running total, for example a total of nutritional values for an entire meal, for that mode, and when the clear key 44 is pressed a third time, in this embodiment, the total for the mode in question is deleted (acting as the answer “yes” to the request for confirmation). It will be understood by persons having ordinary skill in the art that the clear key 44 can be used to clear any entry made in any mode or anywhere on the display, and functions in its most common understood function in the ordinary course of the use of the device.

The “Total” key 46 will shift displayed values from the current weight-derived amount, to the stored running totals, which include the current value, for the selected parameter (or for all parameters, if the TOTAL function has been selected). When pressed a second time, values can be returned to a current or running value. As described in greater detail below the “Tare” key 48 will re-zero the scale. This offset is retained until a new tare is set, or the function is cleared, or the session is ended. (The unit is turned OFF). The On/Off key 50 will turn the scale on or off depending on the current state of the scale. In a preferred embodiment, the scale will turns off automatically after a selected number of minutes, without activity, elapses.

View screen area 30 can include the following display elements and functions: “Weight” window 52 will display the weight determined by placing an item on the scale 14 and can display in either English or Metric units; or in one preferred embodiment both. In one preferred embodiment the user can press the enter key 38, when in the weigh mode, to toggle the display between English and Metric units. The “Code” window 54 displays the user-entered food code, which in a preferred embodiment is a three digit code (1-999). It will be understood by persons having skill in the art that if no code, or zero, is entered all nutrition functions will remain blank, however, the scale will display the weight of the item being weighed. “User #” window 56 displays a designation for the current user of the device. In a preferred embodiment, a total of four users (1-4) can have data stored in the device for recall as desired. In the preferred embodiment a default “User #” is user 1; that is when the scale is turned on, information for user 1 is loaded for use by default. Scale 10 will maintain separate running totals of all parameters for each user.

“Portion” window 58 displays the number of portions selected by the user, to which the amount being weight is to be divided. In a preferred embodiment the food being weighed can be divided into not more than ten portions. In a preferred embodiment the default number of portions is 1. It will be understood that calculated values for nutrients are divided by the portion number when a number other than 1 is displayed. “Calories” window 60 displays total calorie value for selected food code for the amount being weighed (or for a portion, if more than one portion was selected). “Fat Cals” window 62 displays calorie value attributable to fats in the selected food for the amount being weighed (or for a portion, if more than one portion was selected). “Carbs” window 64 displays carbohydrate content for the selected food code for the amount being weighed (or for a portion, if more than one portion was selected). It will be understood by persons having ordinary skill in the art that the display will be in “grams” as this is the common unit used in nutritional information, however, any designation of mass, volume or weight can be used without departing from the novel scope of the present invention. While the designation “grams” is noted throughout the present description it will be understood that any designation for mass, weight, volume or other units can be substituted and that such substitution is within the novel scope of the present invention.

The “Protein” window 66 displays protein content in grams for selected food code for amount being weighed (or for a portion, if more than one portion was selected). “Fat” window 68 displays fat content in grams for selected food code for the amount being weighed (or for a portion, if more than one portion was selected). “Sat Fat” window 70 displays saturated fat content in grams for selected food code for the amount being weighed (or for a portion, if more than one portion was selected). “Fiber” window 72 displays fiber content in grams for selected food code for the amount being weighed (or for a portion, if more than one portion was selected). “Sugars” window 74 displays sugar content in grams for selected food code for the amount being weighed (or for a portion, if more than one portion was selected). “Cholest” window 76 displays cholesterol content in grams for selected food code for the amount being weighed (or for a portion, if more than one portion was selected).

“Bread Eq” window 78 displays the Bread Equivalent value for the selected food for the amount being weighed, for use by diabetics; and “Sodium” window 80 displays the sodium content in grams for selected food code for the amount being weighed (or for a portion, if more than one portion was selected).

A “Timer” window, not shown, displays a count down time. To set Timer, select TIMER mode. Press CLEAR, enter four-digit time (Hours and Minutes; e.g., 0053 for 53 minutes), and then press ENTER to start. The timer may be paused by pressing ENTER again (in the TIMER mode). An alarm will sound when programmed time-out is complete.

“Volume” window 82 shows a conversion, obtainable through use of microprocessor 22, from weight to liquid volume. When desired, the user selects “VOLUME” mode by utilizing the process explained above. The user then presses the Enter key 38 to toggle between Liquids (water-based) and Oils volume determinations. The displayed quantity will be the approximate volume, in fluid ounces, of the liquid material on the scale (with adjustments being possible by virtue of the scale Tare adjustment for the container).

The user can determine a total of the amounts entered for various portions, or for one or more meals by pressing the total key 46. The total key 46 will shift all relevant parameter displays from the immediate value derived from the weight on the scale, to the stored total for each. The designation “YES” will be displayed in the TOTAL window 84. Pressing the total key 46 a second time will restore the current weight-derived parameter values, and the designation “NO” will be displayed in the TOTAL window 84.

In a preferred embodiment a time window can display the current time. In a device having this feature time is set by, select the “TIME” mode and pressing the clear key 44, subsequently the user can enter the time by utilizing the number keys 42 to set the correct time and then pressing the enter key 44.

In the use of the device of the present invention, the user will select a portion of food that, for example, the user desires to consume. The user will then place a container on the weighing element of the device of the present invention and allow the scale to determine the weight of the container. The user can then press the tare key 48 and thereby eliminate the weight of the container from further consideration in the determination of the nutritional values of the food. The user can then place the food portion into the container and allow the device to weigh the portion. The user can then look up a code for the food and enter that code into the keyboard 12 of the scale. It will be understood that various mechanisms, as discussed above, can be utilized to determine the food and its nutritional values. In one embodiment, the user enters a code found in a booklet that accompanies the scale. A code for each type of food and for each food group and general categories of foods can be placed in the booklet, and concomitantly into a memory of the device, so that the device can accurately report the nutritional values of every type of food which a user desires to eat. In another embodiment, a bar code reader permits the user to enter the name or type of food into the device so that nutritional values can be determined, as discussed further below.

Once the type of food is entered into the device of the present invention, the microprocessor 22 determines the nutritional values of the food selected by tapping the information from a memory location 20a within one or more of the memory devices 20 provided in the device of the present invention. Nutritional values of the food selected can be coded or otherwise placed into memory in anyway which provides the desired results and which is known by persons having ordinary skill in the art. Further, as will be understood, data on other foods, not presently available can be updated in memory locations in manners known in the art, and updateable by means know to persons having skill in the art.

The data placed into the memory locations will include a sampling of all the nutritional values previously noted above in a useable form to the microprocessing means of the present invention. Typically, the data can be provided in a per unit basis. For example, if the device is set to read weight in metric units, the data can be entered in a per cubic centimeter basis—e.g. 10 calories per cubic centimeter, 1 gram of fat, etc. If the device is set for English units, the data can be used in a per ounce basis—e.g. 15 calories per ounce, etc. It will be understood that data for both metric and English units can be entered into memory means in a device of the present invention and that the device can have means to present data in either one or both of the units, as desired.

Once the unit values for the food chosen are retrieved by the microprocessor 22, the calculations to determine the values for the portion of food selected, that is based on the weight of the portion, the device will cause the values to be displayed, in the appropriate sections of the screen 18 so that the user can see the values for the food selected.

In one embodiment of the present invention, the values of the particular food can then be caused to be stored in a second memory position 20b. Further, the device permits the user to add values of other foods into the memory of the device, such that the user can determine the nutritional values of an entire meal or a series of meals as desired. Further, in a preferred embodiment, the user can identify his or her data by first entering a user number so that the nutritional values, for a portion, meal or series of meals, can be entered and kept for that specific individual. The user, and or a series of users, can keep track of the nutritional values of the foods consumed for a meal or over a series of meals.

In one embodiment, a device of the present invention, can have means 102 so that it can be connected to a telephone line, a personal computer, removable memory means 114 or other devices such that the data stored in the memory 20 can be used for additional health purposes. For example, in one embodiment, the device can upload data stored to a user's physician, either through a modem device 112 or through connection of the device to a personal computer and then through, for example, the Internet or other networking means. The user can then at one time, or continually, link data concerning his or her diet to a personal physician or dietician, so that professional analysis of the users intake of food can be made. In other embodiments, the device can contain a reader/writer for a portable memory chip 114, such as a “CF” memory of the type presently being used in digital cameras and the like, such that the user may carry his data wherever he goes and measure his intake, and other nutritional values, using a similar device at the users present location. In this manner, nutritional value scales of the present invention can be used at restaurants and other places, as well as users can record their data at the homes of friends and at other places where meals are consumed. The card can be placed within the reading device of the machine and a user code of “guest” can be selected so that the values are recorded in the “guest” card, rather than in the memory location of a fixed memory device within the device of the present invention. It will be understood by persons having skill in the art that various other means to transfer data can be utilized with the device of the present invention, without departing from the novel scope of the present invention.

While a particular screen has been shown and described, it will be understood by persons having ordinary skill in the art that the screen of the present invention can be of a type that can be reconfigured by the user to give information in other ways. Further, the device/screen can include means to provide alarms, at an indication that one or more element, such as “fat” has exceed the “RDA” for that individual.

Further, software in the device, or loadable into the device, can include means 104, 106 to decipher the bar coding that is required on all food labels. This in association with devices capable of reading and deciphering bar coding, which can be included with the scale 10, can provide the nutritional values of a particular food as provided by manufacturers. In this way the scope of foods covered by the device of the present invention is continually expandable. Referring to FIG. 6, the rear panel 100 of scale 10 is shown having a number of ports 102 of various types, known to persons having skill in the art.

For example, with a bar code reader 104 included with the device, either as an attached or attachable wand (not shown) through a port 106, or as an built in reader (such as a grocery store UPC label reader) 104. The user can place a portion of the product on the scale, have the bar code reader device read the bar code (or numerically enter the bar code numbers by using the keyboard) and have the computer 22 determine the nutritional values based on the weight and stored information of nutritional values from the manufacturer's label report; as opposed to general values for that type of food.

In another embodiment of the device of the present invention, a “USB” port 108 and/or other ports, such as a serial port 11 0, can be provided to allow a person to download new software and product information, or subscribe to downloads on a regular basis. Further a modem 112, can also be included to permit the user to upload their personal food intake information to their home computer or email to their physician. Other means of connection to outside sources, such as through an Internet connection, wireless connection cards, Blue Tooth® technology or other means known to persons having skill in the art are possible without departing from the novel scope of the present invention.

Further, the scale 10 can include a memory card port 114 for the use of small memory data cards, such as “CF” or other data cards, or a PCMCIA standard card, including drivers, so that information can be stored onto such cards and taken from one scale to another, or added to the home computer. The use of such memory card ports 114, further allows for the user to insert “CF” or other sized, modems and communications means to add additional functionality to the device.

It will be understood that the device of the present invention can be made such that when up linking to a computer the device can use software that will allow data to be useable in Windows, Linux or Mac system, can use the data in a spreadsheet, etc., in a manner known to persons having skill in the art.

Although illustrative embodiments of the invention has been shown and described, it is to be understood that various modifications and substitutions may be made by those skilled in the art without departing from the novel spirit and scope of the invention.

1. A nutritional value determination, display and storage device, comprising:
a scale for weighing foods;
a computer having a microprocessor, one or more memory means and input means;
data stored in at least one of the one or more memory means, the data including information on nutritional values of foods;
a screen for viewing all nutritional values of a selected food simultaneously;
whereby, when a portion of a food is placed on the scale and the type of food is entered into the computer by the input means, nutritional values can be determined and all simultaneously displayed on the screen for comparison.

2. The nutritional value determination, display and storage device of claim 1, wherein the nutritional information determined is stored in one or more of the one or more memory means.

3. The nutritional value determination, display and storage device of claim 2, including means to add the nutritional information determined for one food to information determined for another food and storing the combined information in one or more of the one or more memory means.

4. The nutritional value determination, display and storage device of claim 2, wherein the nutritional information stored in one or more of the one or more memory means is assigned to one user.

5. The nutritional value determination, display and storage device of claim 4, wherein nutritional information for food for more than one user can be determined and can be stored in one or more of the one or more memory means such that each user can subsequently retrieve his data from storage.

6. The nutritional value determination, display and storage device of claim 4, wherein further nutritional information can be determined and can be added to the information stored in one or more of the one or more memory means.

7. The nutritional value determination, display and storage device of claim 1, wherein the input means is a keyboard.

8. The nutritional value determination, display and storage device of claim 7, wherein the keyboard is a touch screen device.

9. The nutritional value determination, display and storage device of claim 1, wherein a tare function is included such that the weight of a container is not included in the calculations of nutritional values.

10. The nutritional value determination, display and storage device of claim 7 wherein the keyboard comprises means to control the mode of the device.

11. The nutritional value determination, display and storage device of claim 1, wherein the displayed values on the screen include indications of bread equivalents of the food.

12. The nutritional value determination, display and storage device of claim 1, wherein the displayed values on the screen include indications of general calories, calories from fats, carbohydrates, proteins, fat, saturated fat, fiber, sugars, cholesterol and sodium.

13. The nutritional value determination, display and storage device of claim 1, including means to move data stored in the one or more memory means to a second device.

14. The nutritional value determination, display and storage device of claim 1, including personal computer attachment means.

15. A nutritional value determination, display and storage device, comprising:
a scale for weighing foods;
a computer having a microprocessor, one or more memory means and a keyboard;
data stored in at least one of the one or more memory means, the data including information on nutritional values of foods;
a screen for viewing all nutritional values of a selected food or foods simultaneously and for viewing mode and data entry of the device;
the keyboard having data entry keys and mode changing keys;
whereby, when a portion of food is placed on the scale and the type of food is entered into the computer by the keyboard, nutritional values can be determined and all simultaneously displayed on the screen for comparisons, the nutritional values being storable in one or more of the one or more memory means; and
including means to add the nutritional information determined for one food to information determined for another food and storing the combined information in one or more of the one or more memory means.

16. The nutritional value determination, display and storage device of claim 15, wherein the nutritional information stored in one or more of the one or more memory means is assigned to one user.

17. The nutritional value determination, display and storage device of claim 16, wherein nutritional information for food for more than one user can be determined and can be stored in one or more of the one or more memory means such that each user can subsequently retrieve his data from storage.

18. The nutritional value determination, display and storage device of claim 16, wherein further nutritional information can be determined and can be added to the information stored in one or more of the one or more memory means.

19. The nutritional value determination, display and storage device of claim 15, wherein the keyboard is a touch screen device.

20. The nutritional value determination, display and storage device of claim 15, wherein a tare function is included such that the weight of a container is not included in the calculations of nutritional values.

21. The nutritional value determination, display and storage device of claim 15, wherein the displayed values on the screen include indications of bread equivalents of the food.

22. The nutritional value determination, display and storage device of claim 15, wherein the displayed values on the screen include indications of general calories, calories from fats, carbohydrates, proteins, fat, saturated fat, fiber, sugars, cholesterol and sodium.

23. A method of determining nutritional values of foods, comprising the steps of:
providing a scale for weighing foods;
providing a microprocessor and one or more memory means;
providing general nutritional data for a number of foods within the one of the one or more memory means;
providing input means to identify a selected food to the microprocessor;
weighing a portion of food on the scale;
entering a code associated with the weighed food into the microprocessor using the input means, and
providing a screen, associated with the microprocessor, for simultaneous display of all of the nutritional data information associated with the food and provided by the microprocessor.

24. The method of claim 23, including the step of providing means to store and subsequently retrieve the nutritional values displayed in one of the one or more memory means.

25. The method of claim 23, including the step of providing means to store and retrieve nutritional values displayed for one or more users in one or more of the one or more memory means.

26. The method of claim 23, including the step of weighing a second portion of food, determining the nutritional values of the second portion, adding those values to the values determined for the first weighed portion of food and displaying alternatively the summed values, and the individual values.

27. The method of claim 23, including the step of providing means to determine nutritional values of foods for one or more users.
